(19) United States
(12) Patent Application Publication
(10) Pub. No.: US 2006/0241960 A1
(43) Pub. Date: Oct. 26, 2006

(54) Business function control method for a print type calculator

(75) Inventor: Wei-Siang Huang, Taipei County (TW)

Correspondence Address: BACON & THOMAS, PLLC, 625 SLATERS LANE, FOURTH FLOOR, ALEXANDRIA, VA, 22314, US

(73) Assignee: Kinpo Electronics, Inc., Taipei (TW)

(21) Appl. No.: 11/139,645

(22) Filed: May 31, 2005

(30) Foreign Application Priority Data
Apr. 25, 2005 (CN) 200510066971.7

(51) Int. Cl. G06Q 99/00

(52) U.S. Cl. 705/1

(57) ABSTRACT

A business function control method for a print-based calculator, having a printer, a display screen, a key set, and COST, SELL and MARGIN % buttons. A first condition input step is provided to input a value of one of the COST, SELL and MARGIN % conditions as a first condition for being displayed on the display screen and printed by the printer. A second condition input step is provided to input a value of one of the remaining conditions as a second condition for being printed by the printer. A calculation step is provided to calculate a value of the remainder for being displayed on the display screen and printed by the printer, and also to calculate a net profit (SELL-COST) for print.

### BACKGROUND OF THE INVENTION

1. Field of the Invention

The invention relates to a business function control method for a print type calculator.

2. Description of Related Art

FIG. 1 is a schematic view of a typical print type calculator with business functions. As shown in FIG. 1, the calculator has a printer 11, an LCD display screen 12, a keypad 13 containing digits and operation buttons, and manufacturing cost ‘COST’, selling price ‘SELL’ and margin percent ‘MARGIN %’ buttons to provide business function operations among the COST, SELL and MARGIN % conditions. FIG. 2 is a control flowchart of FIG. 1. FIG. 3 is an operation example of FIG. 2. As shown in FIGS. 2 and 3, a business function operation is provided to input a first condition (step S201), which is a value of one of the COST, SELL and MARGIN % conditions, i.e., 100[COST], and thus in this case, the LCD display screen 12 shows’ COST 100.’ and the printer 11 prints ‘100.C*’, which represent the first condition as the cost of 100 dollars. Next, step S202 inputs a second condition, which is a value of one of the remaining conditions, and thus in this case, ‘125[SELL]’ is input and the printer 11 prints 125.**, which represent the second condition as a price of 125 dollars. At this point, a value of the remainder (MARGIN %) is calculated and printed (step S203). In this example, the calculator is based on the input COST and SELL to calculate the MARGIN % as a value of 20, the LCD display screen 12 shows ‘MARGIN % 20.’, and the printer 11 prints ‘20.M %’, which indicate a margin percent of 20 under the first and second conditions, and the printer performs a paper feed. Next, a user can press the COST, SELL or MARGIN % buttons to call the corresponding value (step S204) for display and print for being browsed by the user.

The user in such a business function operation can only know the relation among the COST, the SELL and the MARGIN % without the actual profits, and if the user needs to change one of the COST, the SELL and the MARGIN %, re-inputting all conditions is required. Therefore, the use of such a calculator with business function is inconvenient and it is desirable to provide an improved method to mitigate and/or obviate the aforementioned problems.

### SUMMARY OF THE INVENTION

The object of the invention is to provide a business function control method for a print type calculator, which can overcome the cited problems.

To achieve the object of the invention, a business function control method for a print type calculator is provided, which is used in a print type calculator including a printer, a display screen, a keypad, and manufacturing cost (COST), selling price (SELL) and margin percent (MARGIN %) buttons to provide business function operations among the COST, SELL and MARGIN % conditions. The method includes: a first condition input step to input a value of one of the COST, SELL and MARGIN % conditions as a first condition for being displayed on the display screen and printed by the printer; a second condition input step to input a value of one of the remaining conditions as a second condition for being printed by the printer; a calculation step to calculate a value of the remainder for being displayed on the display screen and printed by the printer, and also to calculate a net profit (SELL-COST) for print; a call step to press the COST, SELL or MARGIN % button for calling, displaying and printing a corresponding value; and a condition re-input step to change the first condition into the corresponding value of the COST, SELL or MARGIN % condition that is the last one displayed on the LCD display screen, and to execute the input second condition step.

Other objects, advantages, and novel features of the invention will become more apparent from the following detailed description when taken in conjunction with the accompanying drawings.

### BRIEF DESCRIPTION OF THE DRAWINGS

FIG. 1 is a schematic view of a typical print type calculator with business functions;

FIG. 2 is a flowchart of a typical business control method for a print type calculator;

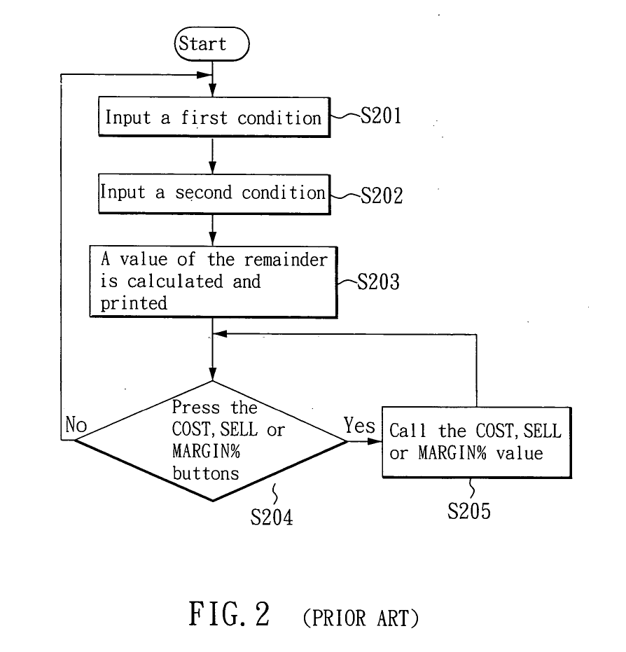

FIG. 3 is an operation example of FIG. 2;

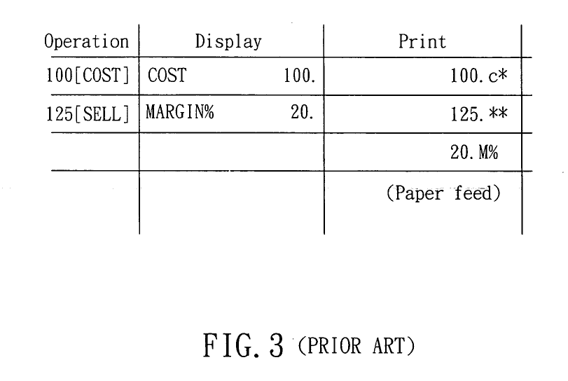

FIG. 4 is a flowchart of a business control method for a print type calculator according to the invention; and

FIG. 5 is an operation example of FIG. 4.

### DETAILED DESCRIPTION OF THE PREFERRED EMBODIMENT

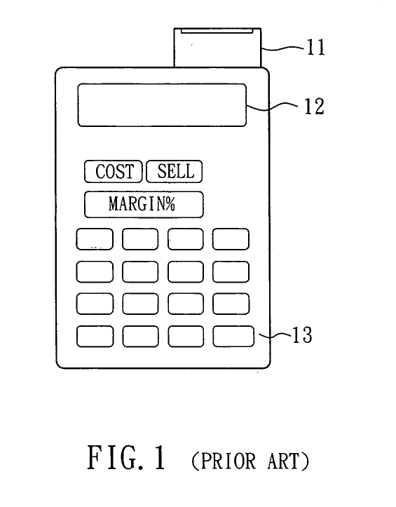

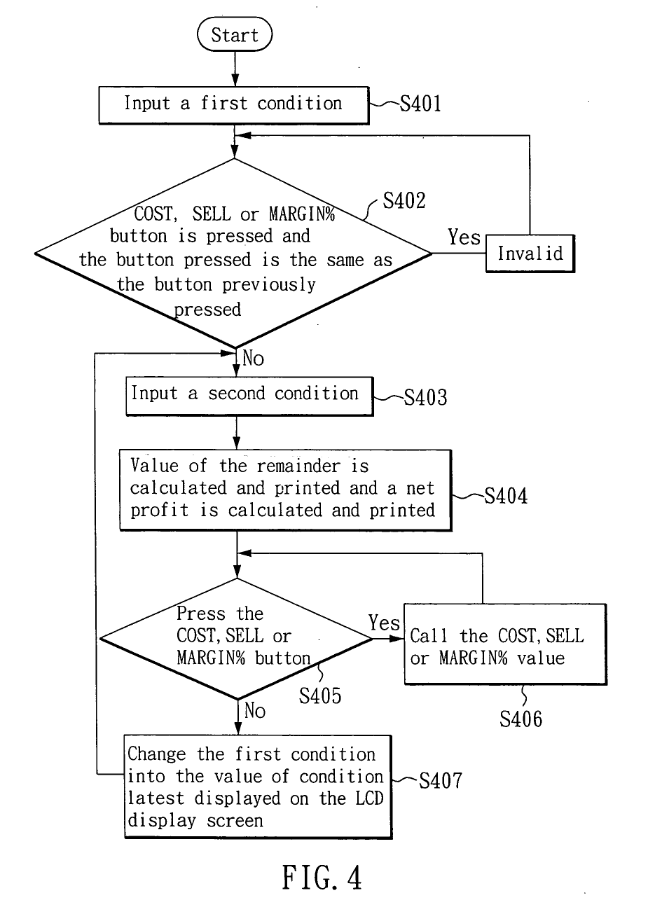

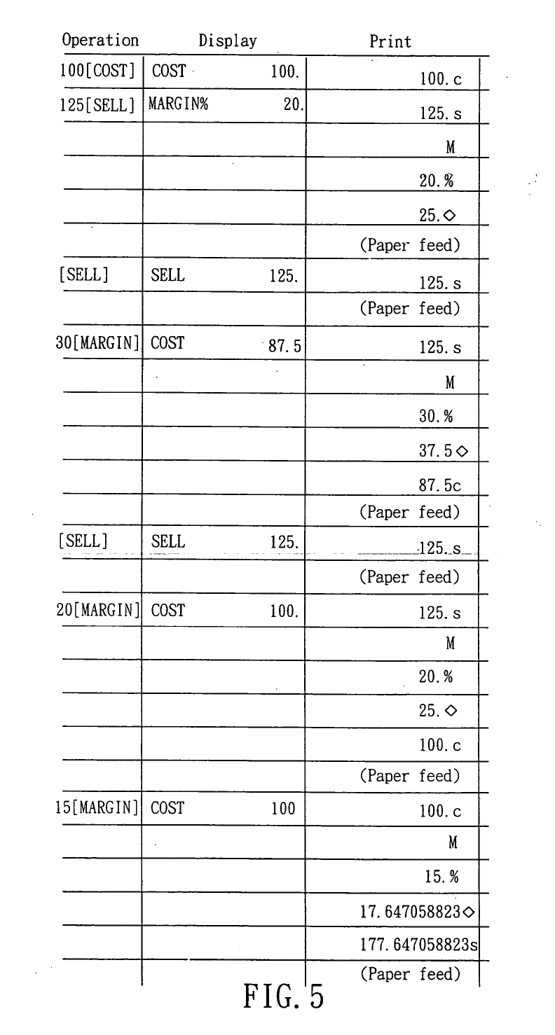

Referring to FIGS. 4 and 5 upon the structure of FIG. 1, step S401 inputs a first condition, which is a value of one of the COST, SELL and MARGIN % condition, i.e., ‘100[COST]’, and thus in this case, the LCD display screen 12 shows ‘COST 100.’ and the printer 11 prints ‘100.C*’, which represent the first condition as the cost of 100 dollars. Next, step S402 determines if the COST or SELL MARGIN % button is pressed and the button pressed is the same as the one previously pressed; if yes, the first condition input is invalid; and if not, step S403 is executed to input a second condition, such as a value of one of the remaining conditions, and thus in this case, ‘125[SELL]’ is input and the printer 11 prints 125.S, which represent the second condition as a price of 125 dollars. At this point, a value of the remainder (i.e., MARGIN %) is calculated and printed. Also, a net profit (SELL-COST) is calculated and printed (step S404). In this case, the calculator is based on the input COST and SELL to calculate the MARGIN % as a value of 20 and the net profit as a value of 25 (125-100). Next, the LCD display screen 12 shows ‘MARGIN % 20.’, and the printer prints ‘20.M %’ and ‘25. ⋄’, which indicate a margin percent of 20 and a net profit of 25 under the cited first and second conditions, and the printer performs a paper feed.

Next, a user can press the COST, SELL or MARGIN % button to call the corresponding value (step S405) for display and print (step S406). In this case, the manufacturing price button SELL is pressed to call the input SELL value. Thus, the LCD display screen 12 shows ‘SELL 125’, and the printer prints ‘125.S’ and performs a paper feed. Step S407 changes the first condition into the value of the manufacturing cost ‘COST’, selling price ‘SELL’ or margin percent ‘MARGIN %’ condition that is latest displayed on the LCD display screen. In this example, the SELL value of 125 is the latest displayed on the LCD display screen 12 and regarded as the first condition. Next, the second condition is re-input and steps S403 to S407 are repeated. That is, a value of one of the remaining conditions, i.e., the COST and MARGIN %, is input as the second condition, and the printer 11 prints the values of the changed first condition and re-input second condition. In this case, ‘30[MARGIN]’ is input as the second condition, and thus the printer 11 prints ‘125.S’ and ‘M 30.%’ respectively to represent the first condition as the SELL value of 125 and the second condition as the MARGIN % value of 30. Next, the calculator calculates a value of the remainder, i.e., the COST condition for display and print, and also a corresponding net profit (SELL-COST) for print (step S404). In this case, the calculator calculates the COST value of 87.5 and the net profit of 37.5 (=125−87.5) according to the SELL value and the input MARGIN % value, and thus the LCD display screen 12 shows ‘COST 87.5’ and the printer 11 prints ‘37.5⋄’ and ‘87.5C’, which indicate a net profit of 37.5 and a price of 87.5 under the cited first and second conditions, and the printer performs a paper feed.

Similarly, the COST, SELL or MARGIN % button can be pressed to call the corresponding value for display as the first condition, and next a new second condition is input to find a result. As cited, the SELL button is re-pressed to call the SELL value out, the LCD display screen 12 shows ‘SELL 125.’, and the printer 11 prints ‘125.S’ and performs a paper feed. In this example, ‘SELL 125.’ displayed on the LCD display screen 12 is regarded as the first condition and ‘20[MARGIN] is input as the second condition, and thus the printer prints ‘125.S’ and ‘M 20.%’. Accordingly, the calculator calculates a COST value of 100 and a net profit of 25 (=125−100). Thus, the LCD display screen 12 shows ‘COST 100.’, and the printer 11 prints ‘25.⋄’ and ‘1005C’ and performs a paper feed.

Accordingly, other results can be found with different conditions. For example, when inputting a second condition as ‘15[MARGIN]’, because the latest displayed one on the LCD display screen 12 is ° COST 100.’, the first condition is changed into ‘COST 100’ and thus the printer 11 prints ‘100.C’ and ‘M 15.%’. Accordingly, the calculator calculates a SELL value of 177.647058823 and a net profit of 77.647058823 (=177.647058823−100). At this point, the LCD display screen 12 still shows ‘COST 100.’, and the printer 11 prints ‘77.647058823⋄’ and ‘177.647058823S’ and performs a paper feed.

In view of the foregoing, it is known that, when performing a business function operation and meeting with a paper feed, the printer can re-print all input conditions such that a user can accordingly view the result(s) clearly in reference with the printed conditions. Also, the actual profit is obtained and printed with the result calculation, such that the user can view all information when finding the result and does not need to update all inputs for a new calculation. In addition, the invention can use any input or result as the first condition to accordingly obtain the functions of reverse calculation, price comparison, and repeat calculation with a fixed condition.

Although the present invention has been explained in relation to its preferred embodiment, it is to be understood that many other possible modifications and variations can be made without departing from the spirit and scope of the invention as hereinafter claimed.

What is claimed is:

1. A business function control method for a print type calculator, which is used in a print type calculator including a printer, a display screen, a keypad, and manufacturing cost (COST), selling price (SELL) and margin percent (MARGIN %) buttons to provide business finction operations among the COST, SELL and MARGIN % conditions, the method comprising:
a first condition input step, to input a value of one of the COST, SELL and MARGIN % conditions as a first condition for being displayed on the display screen and printed by the printer;
a second condition input step, to input a value of one of the remaining conditions as a second condition for being printed by the printer; and
a calculation step, to calculate a value of the remainder for being displayed on the display screen and printed by the printer, and to calculate a net profit (SELL-COST) for print.

2. The method as claimed in claim 1, further comprising an invalid determining step between the first condition input step and the second condition input step, which determines if the COST, SELL or MARGIN % button is pressed and the button pressed is the same as the button previously pressed as the first condition; if yes, the first condition input is invalid.

3. The method as claimed in claim 1, wherein in the calculation step, after the net profit is printed, the printer performs a paper feed.

4. The method as claimed in claim 1, further comprising a call step, to press the COST, SELL or MARGIN % button for calling, displaying and printing a corresponding value.

5. The method as claimed in claim 4, wherein in the call step, after the corresponding value is printed, the printer performs a paper feed.

6. The method as claimed in claim 1, further comprising a condition re-input step, to change the first condition into the value of the COST, SELL or MARGIN % condition that is latest displayed on the LCD display screen, and to execute the second condition input step.
